(19) United States
(12) Patent Application Publication
(10) Pub. No.: US 2009/0027663 A1
(43) Pub. Date: Jan. 29, 2009

(54) Method of detecting sources of coherent radiation and a device utilising the method

(76) Inventor: Soren Svensson, Linkoping (SE)

Correspondence Address: JACOBSON HOLMAN PLLC, 400 SEVENTH STREET N.W., SUITE 600, WASHINGTON, DC, 20004, US

(21) Appl. No.: 11/795,040

(22) PCT Filed: Dec. 8, 2005
(86) PCT No.: PCT/SE05/01869

§ 371 Date: Apr. 8, 2008

(30) Foreign Application Priority Data
Jan. 11, 2005 (SE) 0500067-4

(51) Int. Cl. G01J 1/42

(52) U.S. Cl. 356/218

(57) ABSTRACT

The present invention relates to a method of detecting sources of coherent radiation, which is achieved by depicting, simultaneously or at times close to each other, that part of the environment which is of interest by a radiation sensor, on the one hand with a vortex mask in front of the sensor (FIG. 2) and, on the other, without such a vortex mask (FIG. 1), and by subtracting the sensor signal from the measurement with a vortex mask from the one without such a mask, and determining the presence of a source of coherent radiation if the differential signal exceeds a predetermined threshold value. The invention also comprises a device using the method.

The present invention relates to a method of detecting sources of coherent radiation and a device using the method.

There are different types of laser sources which on a combat field imply a threat. One example is laser range finders which are used for measuring the distance to targets. The laser sources involved can be so weak that the currently used laser warners which should warn an individual when exposed to laser beams—coherent radiation—have great difficulties in detecting such weak laser sources.

The present invention provides a solution to the problem of detecting weak laser sources by being designed in the way that is evident from the independent claims. The remaining claims define advantageous embodiments of the invention.

The invention will in the following be described in more detail with reference to the accompanying drawings, in which

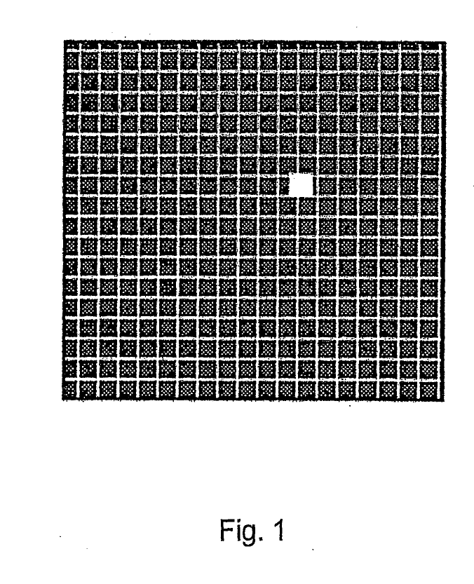

FIG. 1 illustrates an array detector exposed to coherent radiation which has not passed a vortex mask, and

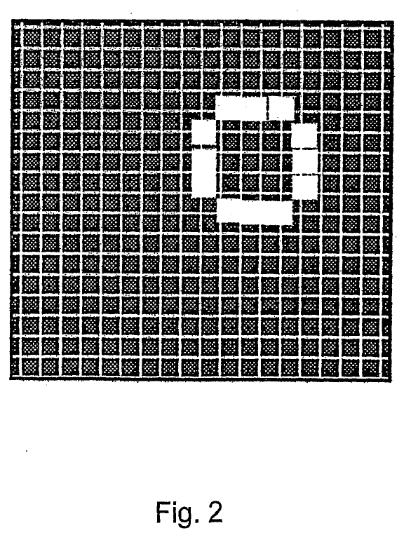

FIG. 2 illustrates an array detector exposed to coherent radiation which has passed a vortex mask.

The basic idea is to depict, simultaneously or at times close to each other, that part of the environment which is of interest by a radiation sensor, on the one hand with a vortex mask in front of the sensor and, on the other, without such a vortex mask.

A vortex mask is an optical component which, in a quick view, seems to be a flat, often circular and transparent, plate. However, the optical thickness varies in a pre-determined manner along circles around the centre of the plate, while the optical thickness is constant along radii from the centre. More specifically, the plate is designed so that the optical thickness d depends on the angle position (0≦φ<2π) in relation to the radius where the plate has a minimum optical thickness so that

d(φ)=d(0)+φ·m·λ/2π

wherein λ is the design wavelength and m is said to be the vorticity of the plate.

If the plate is made of a homogeneous material, its thickness must vary in a manner which is determined by the refractive index and the vorticity m.

With the following definitions
r=distance from the optical axis (centre of the plate),
φ=angle (from the radius with the minimum optical thickness) in the centre of the plate,
n=refractive index of the plate,
D=physical thickness of the plate (function of rand φ) and
D₀=minimum thickness of the plate
   the thickness of the plate is given by the following expressions. The thickness of the plate is continuous except when r or φ is zero.

$$\begin{matrix}D = {D}_{0} + \frac{m λϕ}{2 π ( n - 1 )} & when r \neq 0 \\ D = {D}_{0} & when r = 0\end{matrix}$$

Instead of changing the physical thickness of the plate, it is possible to change its refractive index or combine a change of the physical thickness and a variable refractive index.

Different techniques of producing a vortex mask are described in the following two publications, hereby incorporated by reference. K. Sueda, G. Miyai, N. Miyanaga and M. Nakatsuka: “Laguerre-Gaussian beam generated with a multilevel spiral phase plate for high intensity laser pulses”, Optics Express, 26 Jul. 2004, Vol. 12, No. 15, 3548 and S. S. R. Oemrawsingh, E. R. Eliel, J. P. Woerdman, E. J. K. Ver-stegen, J. G. Kloosterboer and G. W. 't Hooft: “Half-integral spiral phase plates for optical wavelengths”, J. Opt. A: Pure Appl. Opt. 6(2004), pp 288-290.

If a vortex mask is placed in front of an objective, coherent radiation at the design wavelength will not be focused as sharply as before. A parallel coherent beam does not produce a point in the image plane, but a concentric ring pattern with a dark centre. Incoherent radiation is not affected to the same extent and therefore still produces sharp images.

The present case involves one measurement with a vortex mask and one without, the sensor signal from the measurement with a vortex mask being subtracted from the one without such a mask. Thus the process involves subtracting the incoherent radiation, which is the one measured with the vortex mask, from the total radiation, which is measured without the vortex mask, the coherent radiation constituting the difference and being the one that is to be detected. When the incoherent radiation has been eliminated, it is much easier to detect the coherent radiation.

In concrete terms, the subtraction can occur by the exposure of each pixel in the detector in prior-art manner being represented by a numerical value, so that the numerical values of the pixels jointly form a matrix per image. One matrix is numerically subtracted from the other, the pixels being exposed only to incoherent radiation having the same numerical value in both matrices whereas radiation with a long coherent length reaches different pixels in the two matrices, cf. FIG. 1 which shows an array detector exposed to coherent radiation which has not passed a vortex mask, and FIG. 2 which shows an array detector exposed to coherent radiation which has passed a vortex mask. An image subtraction therefore results in zero in the pixels which are only exposed to incoherent light and values different from zero in the positions in the image plane where coherent radiation is affected by the vortex mask.

For measuring, it is possible to use two identical sensors, one with and one without a vortex mask, and perform the measurements simultaneously. However, it is also possible to use one sensor and a device which alternately inserts the vortex mask into the beam path and removes it from the same, and perform the measurements alternately with and without the mask in the beam path. The principle is the same.

Although an optimal effect is achieved when using a vortex mask with 360 degrees phase shift, which may direct the thoughts to the effect being narrowband, a vortex mask functions for a very wide wavelength range, even if the most marked effect occurs for the wavelengths that obtain this phase shift.

The use of a vortex mask in the beam path to a sensor has several properties which are good in the context in addition to the primary function of spreading coherent radiation. Thus a vortex mask basically does not affect the other properties of the optics. In addition, the mask is a thin optical component in the beam path, which means that it is possible to use it not only in new constructions, but also in modifications of existing optics.

The fact that the effect in question gives the desirable properties has been tested with good results in simulation of optical propagation by means of the commercially available software package ASAP from Breault Research Organization.

1. A method of detecting sources of coherent radiation, characterised by depicting, simultaneously or at times close to each other, that part of the environment which is of interest by a radiation sensor, on the one hand with a vortex mask in front of the sensor and, on the other, without such a vortex mask, and by subtracting the sensor signal from the measurement with a vortex mask from the one without such a mask, and determining the presence of a source of coherent radiation if the differential signal exceeds a predetermined threshold value.

2. A method as claimed in claim 1, characterised by using two identical sensors, one with and one without a vortex mask and performing the measurements simultaneously.

3. A method as claimed in claim 1, characterised by using one sensor and a device which alternately inserts the vortex mask into the beam path and removes it from the same, and performing the measurements alternately with and without the mask in the beam path.

4. A method as claimed in claim 1, characterised in that the mask and its holder are designed so that, when the mask is to be in the beam path, all beams reaching the optical system have passed through the mask, and that all beams which within the field of vision of the optics pass through the mask also reach the focal plane of the optics.

5. A device for detecting sources of coherent radiation, characterised in that it comprises
either a radiation sensor and a device which alternately inserts a vortex mask into the beam path and removes it from the same or two identical radiation sensors, one with a vortex mask in the beam path and the other without such a mask, and
a measuring device which in the first case alternately performs measurements with and without the mask in the beam path and, in the second case, performs measurements based on the two sensors, and
a calculating device which subtracts the sensor signal from the measurement with a vortex mask from the one without such a mask and determines the presence of a source of coherent radiation if this signal exceeds a predetermined threshold value.

6. A device as claimed in claim 5, characterised in that the mask and its holder are designed so that, when the mask is to be in the beam path, all beams reaching the optical system have passed through the mask, and that all beams which within the field of vision of the optics pass through the mask also reach the focal plane of the optics.

7. A method as claimed in claim 2, characterised in that the mask and its holder are designed so that, when the mask is to be in the beam path, all beams reaching the optical system have passed through the mask, and that all beams which within the field of vision of the optics pass through the mask also reach the focal plane of the optics.

8. A method as claimed in claim 3, characterised in that the mask and its holder are designed so that, when the mask is to be in the beam path, all beams reaching the optical system have passed through the mask, and that all beams which within the field of vision of the optics pass through the mask also reach the focal plane of the optics.
